(19) United States
(12) Patent Application Publication
(10) Pub. No.: US 2012/0302471 A1
(43) Pub. Date: Nov. 29, 2012

(54) WATERBORNE POLYISOCYANATE COMPOSITION THAT PROVIDES A LOW FRICTION COATING

(76) Inventor: David Scott Webb, Ona, WV (US)

(21) Appl. No.: 13/113,502

(22) Filed: May 23, 2011

(51) Int. Cl. F16C 33/12; F16C 33/20

(52) U.S. Cl. 508/103; 508/100

(57) ABSTRACT

The present invention is a chemical composition that provides a low friction coating and a low sliding coefficient of friction onto a plastic or metal working part that includes a waterborne polyisocyanate such as ureas, urethanes or tetramethylxylene diisocyanates (TMXDI) in the composition structure and a plurality of cross linkable functional groups that include carboxyl groups and hydroxyl groups that are added utilizing plasma or chemical grafting and etching and a plastic or metal chemical substrate. The composition also includes one or more materials that are single linked or multiple linked hydrogels such as polyvinylpyrrolidone (PVP), polyethylene glycol (PEG) or polyvinyl alcohol (PVA) mixed with the polyisocynate and one or more crosslinkers such as aziridines or carbodiimides that link the hydrogels, the polyisocynate and the substrate together to form the composition.

This application claims priority to the priority date of pending U.S. application Ser. No. 13/071,513 filed on 25 Mar. 2011, the entire disclosure of which is incorporated by reference.

### TECHNICAL FIELD & BACKGROUND

The present invention generally relates to a chemical composition that provides a low friction coating. More specifically, the invention is a waterborne polyisocyanate chemical composition that provides a low friction coating.

It is an object of the invention to provide a waterborne polyisocyanate chemical composition that provides a low friction coating that is able to crosslink to a substrate utilizing substrate surface chemistry adjustments creating adhesion and cohesion bonds to the substrate and a plurality of hydrogels.

It is an object of the invention to provide a waterborne polyisocyanate chemical composition that provides a low friction coating that includes hydrogels that can crosslink with themselves and/or with the waterborne polyisocyanate and/or a substrate, with the waterborne polyisocyanate, the substrate and the hydrogels preferably crosslinking together.

It is an object of the invention to provide a waterborne polyisocyanate chemical composition that provides a low friction coating that utilizes two or more cross linkers to adjust the final properties of the composition's adhesion, cohesion and friction.

What is really needed is a waterborne polyisocyanate chemical composition that provides a low friction coating that is able to crosslink to a substrate using substrate surface chemistry adjustments creating adhesion and cohesion bonds to the substrate and a plurality of hydrogels, that includes hydrogels that can crosslink with themselves (i.e., adhesion, cohesion or chemical bond), crosslink with the waterborne polyisocyanate and/or a substrate, with the waterborne polyisocyanate, the substrate and the hydrogels preferably crosslinking together and that provides a low friction coating that utilizes two or more crosslinkers to adjust the final properties of the composition's adhesion, cohesion, chemical bonds and friction.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials, and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

The present invention is a chemical composition that provides a low friction coating and a low sliding coefficient of friction onto a plastic or metal working part, in accordance with one embodiment of the present invention. The chemical composition includes a waterborne polyisocyanate such as ureas, urethanes, esters, ethers and tetramethylxylene diisocyanates (TMXDI) in the chemical composition structure and a plurality of cross linkable functional groups and a plastic or metal chemical substrate. The waterborne polyisocyanate must include cross linkable functional groups. Any suitable waterborne polyisocyanate can be utilized with the chemical composition.

The chemical composition also includes one or more materials are that are single linked or multiple linked hydrogels such as polyvinylpyrrolidone (PVP), polyethylene glycol (PEG) and polyvinyl alcohol (PVA) that are mixed with the waterborne polyisocyanate and one or more crosslinkers that include aziridines and carbodiimides that link the hydrogels, the waterborne polyisocyanate and the substrates together to form the chemical composition. The cross linkers must be able to crosslink with the waterborne polyisocyanate polymer functional chain, and substrates through surface modification. The surface modification includes functional groups grafted to the surface such as hydroxyl and carboxyl groups as an example the can crosslink with the polyisocyanate polymer. The hydrogels should be chosen to crosslink with themselves and/or with the waterborne polyisocyanate chemistry and/or substrate or have a strong adhesion coehesion with the other hydrogels in the formulation. Surface modification of the hydrogels can be used to create functional groups on the surface of the hydrogels capable of crosslinking to the polyisocyante polymer. A best mode for the polyisocyanate composition is to have the hydrogels, waterborne polyisocyanate and functional group substrate cross linkable together to create adhesion, cohesion bond, and chemical bonds for best performance. The preferred surface modifications are to add crosslinkable functional groups to the surface of the substrate that will crosslink with the waterborne polyisocyanate creating adhesion bonds and adhesion bonds (examples of cross linkable functional groups added to the substrate but not limited to include carboxyl and hydroxyl groups. Example methods employed to add functional groups include but not limited to plasma or chemical grafting and etching). The plasma gases compositions that can be used are noted as an example but are not limited to carbon dioxide, ethyl alcohol, acrylic acid or any other suitable plasma gases composition. Also any suitable single linked or multiple crosslinkers can be utilized with the chemical composition.

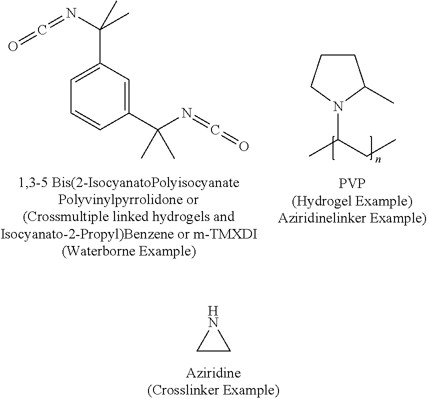

In utilizing the chemical composition, two plastic substrates coated with the chemical composition can rub against each other, a plastic substrate and a metal substrate coated with the chemical composition can rub against each other and two metal substrates coated with the chemical composition can rub against each other. Preferably, the substrates are cross linked to the hydrogels utilizing substrate surface chemistry adjustments creating adhesion and cohesion bonds to the substrate and the hydrogels. The preferred surface modifications are to add functional groups that can be cross linked to the surface of the substrate that will crosslink with the waterborne polyisocyanate creating adhesion bonds.

The waterborne polyisocyanate chemical composition provides a low friction coating that is able to crosslink to a substrate using substrate surface chemistry adjustments creating adhesion and cohesion bonds to the substrate and a plurality of hydrogels. The waterborne polyisocyanate chemical composition provides a low friction coating that includes hydrogels that can crosslink with themselves and/or with the waterborne polyisocyanate and/or a substrate, with the waterborne polyisocyanate, the substrate and the hydrogels preferably crosslinking together. The waterborne polyisocyanate chemical composition provides a low friction coating that also utilizes two or more crosslinkers to adjust the final properties of the chemical composition's adhesion, cohesion and friction. The crosslinkers used can be aziridines or carbodiimides, however any suitable crosslinkers can be used to adjust the final properties of the chemical composition's adhesion, cohesion and friction.

The chemical composition can be utilized in a wide variety of devices that require or would benefit from a low friction coating. For example, the chemical composition can be applied to a medical device to reduce friction upon insertion or implantation of the device into the human body, such as a knee replacement joint, catheters, stents, delivery systems, i.e., injectors, etc.

The following examples illustrate a plurality of formulations, crosslinkers and hydrogels representing a plurality of embodiments of the chemical composition:

### EXAMPLE 1

### Medkote 100-T Top Coat Dry Formulation

Polyester urethane 73.4%+/−2%
Polyvinylpyriliodone 26.33%+/−2%
Polyvinyl alcohol 0.27%+1/−0.27%

### Medkote 100-B Base Coat Dry Formulation

Polyester urethane 100+/−0%

### EXAMPLE 2

### Medkote 200-T Top Coat Dry Formulation

Polyether urethane 73.4%+/−2%
Polyvinylpyriliodone 26.33%+/−2%
Polyvinyl alcohol 0.27%+1/−0.27%

### Medkote 200-B Base Coat Dry Formulation

Polyether urethane 100%
Cross linkers used in both formulations:
Poly-functional aziridine
Carbodimide

### EXAMPLE 3

### Medkote 350-T Dry Formulation

Polyester urethane 36.7%+/−2%
Polyether urethane 36.7%+/−2%
Polyvinylpyriliodone 26.33%+/−2%
Polyvinyl alcohol 0.27%+1/−0.27%

### Medkote 350-B Dry Formulation

Polyester urethane 50%+/−2%
Polyether urethane 50%+/−2%
Cross linkers used in all three formulations:
Poly-functional aziridine 0-50%
Carbodimide 0-50%

In all of the above examples, the base is applied and the top coat is applied on top of the base to form the coating. Other suitable hydrogels and crosslinkers can also be utilized with the formulations in both examples.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A chemical composition that includes a top coat and a base coat that provides a low friction coating onto an object, comprising:
a waterborne polyisocyanate;
a chemical substrate;
one or more materials that form one or more hydrogels mixed with said polyisocynate; and
one or more crosslinkers that link said hydrogels, said polyisocynate and said substrate together to form said composition.

2. The composition according to claim 1, wherein said waterborne polyisocyanate is selected from the group consisting of ureas, urethanes, esters, ethers or tetramethylxylene diisocyanates (TMXDI) in said composition structure, a plurality of cross linkable functional groups, carboxyl groups and hydroxyl groups.

3. The composition according to claim 2, wherein said functional groups are added to said substrate utilizing plasma or chemical grafting and etching.

4. The composition according to claim 3, wherein said plasma grafting and etching utilizes plasma gases that include carbon dioxide, ethyl alcohol and acrylic acid.

5. The composition according to claim 1, wherein said substrates are plastic or metal.

6. The composition according to claim 5, wherein two said plastic substrates coated with said composition can rub against each other, said plastic substrate coated with said composition and said metal substrate coated with said composition can rub against each other and two said metal substrates coated with said composition can rub against each other.

7. The composition according to claim 1, wherein said materials are hydrogels that are single linked or multiple linked.

8. The composition according to claim 1, wherein said materials are selected from the group consisting of polyvinylpyrrolidone (PVP), polyethylene glycol (PEG) or polyvinyl alcohol (PVA).

9. The composition according to claim 1, wherein said crosslinkers are selected from the group consisting of aziridines or carbodiimides.

10. The composition according to claim 9, wherein said substrate is cross linked to said hydrogels utilizing substrate surface chemistry adjustments creating adhesion and cohesion bonds to said substrate and said hydrogels.

11. The composition according to claim 1, wherein said composition utilizes two or more said crosslinkers to adjust said composition's adhesion, cohesion and friction.

12. The composition according to claim 1, wherein said composition includes said top coat selected from the group consisting of the range of 71.4% to 75.4 polyether urethane, the range of 24.33% to 28.33% polyvinylpyriliodone and the range of 0.0% to 1.27% polyvinyl alcohol, a base coat of 100% polyether urethane and said crosslinkers in the range of 0% to 50% poly-functional aziridine and in the range of 0% to 50% carbodimide.

13. The composition according to claim 1, wherein said composition includes said top coat selected from the group consisting of the range of 71.4% to 75.4 polyester urethane, the range of 24.33% to 28.33% polyvinylpyriliodone and the range of 0.0% to 1.27% polyvinyl alcohol, a base coat of 100% polyester urethane and said crooslinkers in the range of 0% to 50% poly-functional aziridine and in the range of 0% to 50% carbodimide.

14. The composition according to claim 1, wherein said composition includes said top coat selected from the group consisting of the range of 34.7% to 38.7% polyester urethane, the range of 34.7% to 38.7% polyether urethane, the range of polyvinylpyriliodone 24.33% to 28.33% and the range of polyvinyl alcohol 0.0% to 1.27% and said base coat selected from the group consisting of the range of 48% to 52% polyester urethane and 48% to 52% polyether urethane and said crosslinkers in the range of 0% to 50% poly-functional aziridine and in the range of and 0% to 50% carbodimide.

15. A chemical composition that provides a low friction coating and a low sliding coefficient of friction onto a working part, comprising:
a waterborne polyisocyanate selected from the group consisting of ureas, urethanes, esters, ethers or tetramethylxylene diisocyanates (TMXDI) in said composition structure and a plurality of cross linkable functional groups that include carboxyl groups and hydroxyl groups;
a plastic or metal chemical substrate;
one or more materials that form one or more hydrogels that are single linked or multiple linked mixed with said polyisocynate; and
one or more crosslinkers selected from the group consisting of aziridines or carbodiimides that link said hydrogels, said polyisocynate and said substrate together to form said composition, wherein said composition utilizes two or more said crosslinkers to adjust said composition's adhesion, cohesion and friction.

16. The composition according to claim 15, wherein said functional groups are added to said substrate utilizing plasma or chemical grafting and etching, wherein said plasma grafting and etching utilizes plasma gases that include carbon dioxide, ethyl alcohol and acrylic acid.

17. The composition according to claim 16, wherein two said plastic substrates coated with said composition can rub against each other, said plastic substrate coated with said composition and said metal substrate coated with said composition can rub against each other and two said metal substrates coated with said composition can rub against each other.

18. The composition according to claim 17, wherein said substrates are cross linked to said hydrogels utilizing substrate surface chemistry adjustments creating adhesion and cohesion bonds to said substrate and said hydrogels.

19. The composition according to claim 15, wherein said materials are selected from the group consisting of polyvinylpyrrolidone (PVP), polyethylene glycol (PEG) or polyvinyl alcohol (PVA).

20. The composition according to claim 15, wherein said composition includes said top coat selected from the group consisting of the range of 71.4% to 75.4 polyether urethane, the range of 24.33% to 28.33% polyvinylpyriliodone and the range of 0.0% to 1.27% polyvinyl alcohol, a base coat of 100% polyether urethane and said crosslinkers in the range of 0% to 50% poly-functional aziridine and in the range of 0% to 50% carbodimide.

21. The composition according to claim 15, wherein said composition includes said top coat selected from the group consisting of the range of 71.4% to 75.4 polyester urethane, the range of 24.33% to 28.33% polyvinylpyriliodone and the range of 0.0% to 1.27% polyvinyl alcohol, a base coat of 100% polyester urethane and said crooslinkers in the range of 0% to 50% poly-functional aziridine and in the range of 0% to 50% carbodimide.

22. The composition according to claim 15, wherein said composition includes said top coat selected from the group consisting of the range of 34.7% to 38.7% polyester urethane, the range of 34.7% to 38.7% polyether urethane, the range of polyvinylpyriliodone 24.33% to 28.33% and the range of polyvinyl alcohol 0.0% to 1.27% and said base coat selected from the group consisting of the range of 48% to 52% polyester urethane and 48% to 52% polyether urethane and said crosslinkers in the range of 0% to 50% poly-functional aziridine and in the range of and 0% to 50% carbodimide.

23. A chemical composition that provides a low friction coating and a low sliding coefficient of friction onto a plastic or metal working part that includes a medical device used for insertion or implementation such as a knee replacement joint, a catheter, a stent, a delivery system, or an iol injector, comprising:
a waterborne polyisocyanate selected from the group consisting of ureas, urethanes, esters, ethers or tetramethylxylene diisocyanates (TMXDI) in said composition structure and a plurality of cross linkable functional groups that include carboxyl groups and hydroxyl groups that are added utilizing plasma or chemical grafting and etching, wherein said plasma grafting and etching utilizes plasma gases that include carbon dioxide, ethyl alcohol and acrylic acid;
a plastic or metal chemical substrate;
one or more materials that are single linked or multiple linked hydrogels selected from the group consisting of polyvinylpyrrolidone (PVP), polyethylene glycol (PEG) or polyvinyl alcohol (PVA) mixed with said polyisocynate; and
one or more crosslinkers selected from the group consisting aziridines or carbodiimides that link said hydrogels, said polyisocyanate and said substrate together to form said composition.

24. The composition according to claim 23, wherein two said plastic substrates coated with said composition can rub against each other, said plastic substrate coated with said composition and said metal substrate coated with said composition can rub against each other and two said metal substrates coated with said composition can rub against each other.

25. The composition according to claim 24, wherein said substrates are cross linked to said hydrogels utilizing substrate surface chemistry adjustments creating adhesion and cohesion bonds to said substrate and said hydrogels.

26. The composition according to claim 25, wherein said composition utilizes two or more said crosslinkers to adjust said composition's adhesion, cohesion and friction.

27. The composition according to claim 23, wherein said composition includes said top coat selected from the group consisting of the range of 71.4% to 75.4 polyether urethane, the range of 24.33% to 28.33% polyvinylpyriliodone and the range of 0.0% to 1.27% polyvinyl alcohol, a base coat of 100% polyether urethane and said crosslinkers in the range of 0% to 50% poly-functional aziridine and in the range of 0% to 50% carbodimide.

28. The composition according to claim 23, wherein said composition includes said top coat selected from the group consisting of the range of 71.4% to 75.4 polyester urethane, the range of 24.33% to 28.33% polyvinylpyriliodone and the range of 0.0% to 1.27% polyvinyl alcohol, a base coat of 100% polyester urethane and said crooslinkers in the range of 0% to 50% poly-functional aziridine and in the range of 0% to 50% carbodimide.

29. The composition according to claim 23, wherein said composition includes said top coat selected from the group consisting of the range of 34.7% to 38.7% polyester urethane, the range of 34.7% to 38.7% polyether urethane, the range of polyvinylpyriliodone 24.33% to 28.33% and the range of polyvinyl alcohol 0.0% to 1.27% and said base coat selected from the group consisting of the range of 48% to 52% polyester urethane and 48% to 52% polyether urethane and said crosslinkers in the range of 0% to 50% poly-functional aziridine and in the range of and 0% to 50% carbodimide.
